(19) United States
(12) Patent Application Publication
(10) Pub. No.: US 2003/0053710 A1
(43) Pub. Date: Mar. 20, 2003

(54) Device of sample rate conversion for digital image and the method of the same

(76) Inventors: Shih-Yu Ku, Hsinchu (TW); Wen-Chang Cheng, Hsinchu (TW)

Correspondence Address: Raymond Sun, 12420 Woodhall Way, Tustin, CA, 92782, US

(21) Appl. No.: 10/191,241

(22) Filed: Jul. 9, 2002

(30) Foreign Application Priority Data
Jul. 10, 2001 (TW) 90116921

(51) Int. Cl. G06K 9/40; G06T 5/00; G06T 3/40

(52) U.S. Cl. 382/264; 382/269; 382/299

(57) ABSTRACT

The present invention is to provide a device and a method of sample rate conversion for digital image. With the present invention, the alias effect caused by shrinking the image and the blurred effect caused by enlarging the image will be eliminated. The device of the present invention comprises a ratio-adjustable expander used to receive image signal, increase the sample rate of the image M times based on the adjusting ratio for the image to generate a expanding signal; a low pass filter (LPF) used to receive the expanding signal from the expander, filter out the high rate and output the filtered signal; and a fix ratio decimator used to receive the filtered signal, low down the sample rate by N times and generate the output signal. The value of M will be changed with the adjusting ratio while the value of the N is fixed. The LPF includes the factor 1+z−1+ . . . +z−(N−1) and the factor 1+z−1+ . . . +z−(M−1).

### BACKGROUND OF THE INVENTION

(a). Field of the Invention

The present invention relates to a device and a method of sample rate conversion. Especially, the present invention relates to a device and a method of sample rate conversion for digital image.

(b). Description of the Prior Arts

The advantages of digitizing a image are that the digital image is easy to transfer, to store and is easy for further process. However, the output format of a digital image could be different with its original one, the process of sample rate conversion is necessary most of time, for example, when a image with 800*600 pixels being transformed to a image with 1024*768 pixels.

As shown in FIG. 1, the sample rate conversion that employing interpolation is processing a digital image. In the FIG. 1(A), a discrete signal (such as a one dimension digital image signal) is using a proper interpolating function (as shown in FIG. 1(B) and FIG. 1(E)) to produce the serial signals as shown in FIG. 1(C) and FIG. 1(F), and then, a new sample rate will be adapted to sample the serial signals to generate a discrete signal with new sample rate. For a two dimensional image signal, a sample rate conversion can be applied on the X direction first, and then Y direction. In the sample of converting the digital image with 800*600 pixels to a digital image with 1024*768 pixels, a X direction sample rate conversion will be applied first to obtain a digital image with 1024*600 pixels and a Y direction sample rate conversion will be applied again to obtain a digital image with 1024*768 pixels. The simplest interpolating function is the linear interpolating function, others function such as spline function or other more complex ones will be adapted in different occasions.

However, the sample rate conversion that employing interpolating function for digital signal is with two serious problems. First, as shown in FIG. 2, is the alias effect that happens in scaling down the image. Second one is the problem of definition that happens in scaling up the image as shown in FIG. 3. In FIG. 2(A), it is showing the rate spectrum of the original digital signal, its sample rate is fS, with the interpolating function, the original signal will be transformed to the spectrum of serial signal as shown in FIG. 2(B), wherein, there is no magnificent change differing from the original signal. But, when using lower sample rate fS′ to sample again, the ½ rate portion that higher rate over the lower rate fS′ will wrap over the lower rate to generate the alias which is the shadow part as shown in FIG. 2(C). The alias will affect the quality of the digital image seriously.

More, in the digital images that we process everyday, some of them are the real images in the real world (such as photo) while some are created by software (such as the image mixing text and image). FIG. 3(A) is showing the discrete signal in the compound digital image with clear boundary. FIG. 3(B) and FIG. 3(A) are showing the serial signals that have been transformed by interpolating function. In FIG. 3(C), it is showing the discrete signal that has been sampled again with the higher sample rate. If the interpolating function not working properly, after the image being transformed, the boundary is blurred.

In FIG. 4, it is showing another way for sample rate conversion, which is adapting the conventional digital signal processing (DSP) to process the sample rate conversion for a dimensional digital signal. As described previously, for a two dimensional digital signal, a X direction sample rate conversion will apply first, and then a Y direction sample rate conversion applies. The following illustration will focus the sample rate conversion that applying on one dimension digital signal. In FIG. 4, the digital signal processor is comprising a expander 41, a low pass filter (LPF) 42 and a decimator 43. In FIG. 4, the uₖ is the array of the input signal, the suffix k is representing the time index of the signal, xₖ is the array of the output signal of the expander 41, yₖ is the array of the output signal of the LPF 42, Zₖ is the array of the output signal of the decimator 43. Wherein, the expander 41 complies the formula:

$${x}_{k m + l} = \{ \begin{matrix}{u}_{k} , & when l = 0 , \\ 0 , & when l = 1 … M - 1\end{matrix} \qquad ( 1 )$$

which means the output signal of the expander 41 is inserting M−1 0s between two signals of the array of the input signal uₖ to enlarge the expanding signal by M times. The output array xₖ will be processed by the LPF 42 to obtain the output Zₖ, and which complies the formula:

$${y}_{k} = {\sum }_{i = 0}^{k - 1} {h}_{i} {x}_{k - 1} \qquad ( 2 )$$

wherein, hᵢ is the impulse response of the LPF 42. For most of the xᵢ are zeros, the formula (2) can be simplified as the formula (3) to reduce the calculation of the LPF 42;

yₖₘ₊ₗ=hᵢ*uₖ+hₗ₊ₘ*uₖ₋₁+hₗ₊₂ₘ*uₖ₋₂+ . . . (3)

and the decimator 43 will comply the following formula;

zₖ=y_{kN} (4)

which means the decimator 43 will select one data from the every N data from the signal array yₖ to obtain the output signal array zₖ to low down the rate by N times.

The impulse response hᵢ of the LPF 42 can be rewritten with the z-transform to be multinomial H(z), which is the LPF 42 transfer function

$$H ( z ) = {\sum }_{i = 0}^{k - 1} {h}_{i} * {z}^{- i} \qquad ( 5 )$$

There are two advantages to use the multinomial to express the impulse response of signal array or system. First, the output signal array of a system must be expressed by the convolution of the input signal array and its impulse response (such as formula (2)). If the input signal, the output signal of the system and the impulse response of the system are expressed by the multinomial of z-transform, the output will be the multinomial product of the input and the system transfer function (for example, the formula (2) can be expressed as Y(z)=H(z)X(z), wherein, the X(z) and Y(z) are representing the multinomial that being transformed from the input signal and the output signal with the z-transform respectively, the H(z) is the transfer function of the LPF). When a few systems connected together, the expression of multinomial will show the convenience. Second, The rate response of a system can be obtain directly from the z-transform function (in the system with transfer function H(z), the rate response is H(e^{jw})), so, when analyzing the rate response of a system, it is convenient to adapt z-transform.

The z-transform, the design of filter and the sample rate conversion with fix ratio are the common technology used in prior art in digital signal process (referring to Oppenheim, Schafer and Buck, “Discrete-Time Signal Processing”). So, if the transform ratio is fix, it is efficient to low down the alias effect if adapting the conventional technology of digital signal process to design the transfer function H(z) of a LPF. Meanwhile, in order to enhance the definition of a image, the transfer function H(z) can be designed in various type with different rate make-up intensity for user's selection.

When a system processing the sample rate conversion, the transform ratio should be adjustable but not fix. When said method adapted, there can be two options; first, the expanding ratio is fix and the decimating ratio is adjustable, second, the expanding ratio is adjustable and the decimating ratio is fix. However, when a system needs a big range of rate conversion, for example, from 25% to 200%, the both options will not cover the whole range with a certain LPF. In general, in order to avoid the alias effect happened on the output signal after decimating, the rate spectrum filtered by the prior LFP should be adjusted based on the decimating ratio N. FIG. 5(A) and FIG. 5(B) are showing the rate range that should be filtered out by the LFP to avoid the alias effect in two different decimating ratio N, wherein, the decimating ratio N is 3 in FIG. 5(A) and the N is 9 in FIG. 5(B). From the figure, we understand the LPF is different depending on the N, therefore, in the first option (the expanding ratio N is fixed, the decimating ratio N is adjustable), the impulse response of the LPF can not be fixed. In the second option (the expanding ratio N is adjustable, the decimating ratio N is fixed), when the image is being enlarged, the sample rate of the output signal is higher than the sample rate of the input signal, the output signal is with wilder rate spectrum. In FIG. 5(C), the shadow portion is the ratio spectrum of the output signal, but is not with the original image. In order to filter out the shadow portion, or to apply proper signal process on the shadow portion, the rate response of the LPF will be changed depending on the variable M. In this case, a certain type LPF can not be used.

Example that a system that will change digital signal between 25% to 200% with 1% precision, if every single ratio needs a set of LPF, in this case, the system will need 175 set of LPF for impulse response; that will take too much memory space. Ideally, the ratio can be divided into several ranges, for example, 25% to 35%, 36% to 50%, 51% to 70%, 71% to 99%, 101% to 140% and 141% to 200%, and every range adapts proper LPF impulse response. If the sharpness of the output image should be adjustable, every range should provide 5 sets of LPF impulse response for user's selection, then, totally 30 sets of LPF impulse response will be needed.

However, dividing the ratio into ranges will certainly reduce the number of LPF, but the LPF used in one certain range will not provide the best filtering effect for every ratio within the range, for example, the LPF made for 42%, when the ratio changed to 36%, the filtering effect it provides will not be as good as the LPF made for 36%. Especially, the declination of the stopband of the LPF is limited, the high rate after declining will wrap over back to low rate to create the alias effect. When the transform ratio of the image is fixed, bigger declination can be applied on the certain rate affected by the alias effect to filter out this certain rate as possible, however, the transform ratio is not fixed, it can not be predicated that which rate within the stopband will be wrapped over by the alias effect to affect the vision seriously. To solve this problem, the level of the LPF should be increased to low down the declination in every portion of the stopband to assure that the alias effect will not affect the vision, however, it takes much more cost.

### SUMMARY OF THE INVENTION

The primary aspect of the present invention is to provide a device of sample rate conversion and the method of the same, which will handle the adjustable ratio digital image without extra memory chip.

Another aspect of the present invention is to provide a device of sample rate conversion and the method of the same; with the hypothesis that the ratio of the image is adjustable, to control the alias effect effectively to assure the quality of the digital image that being transformed.

The device of sample rate conversion of the present invention comprises: a expander used to receive a image signal and increase the rate of the received image signal by M times based on the ratio to generate a expanding signal; a low pass filter (LPF) used to receive the expanding signal of the ratio-adjustable expander, filter out the high rate signal and output the filtered signal; and a decimator used to receive the filtered signal from the LPF, reduce the rate of the received signal by N times and generate the output signal.

Within the sample rate conversion device of the present invention, the LPF is including the factor 1+z⁻¹+ . . . +z^{-(N-1)} and the factor 1+z⁻¹+ . . . +z^{-(M-1)}.

### BRIEF DESCRIPTION OF THE DRAWINGS FIG. 1 shows the diagram of the sample rate conversion that adapting the interpolating.

FIG. 2 shows the alias effect that happens when the image scaling down.

FIG. 3 shows the blurred effect that happens when the image scaling up.

FIG. 4 shows the diagram of the sample rate conversion that adapting another digital signal processor.

FIG. 5 shows the rate range that low pass filter should filter out with two different decimating ratio N, wherein, the decimating ratio N is 3 in FIG. 5(A) and the decimating ratio N is 9 in FIG. 5(B).

FIG. 6 shows the structure diagram of the sample rate conversion for digital image of the present invention.

FIG. 7 shows another structure diagram of the sample rate conversion for digital image of the present invention.

FIG. 8 shows the rate response generated by the low pass filter with factor.

FIG. 9 shows another rate response generated by the low pass filter with factor.

FIG. 10 shows the flow chart of the method of the sample rate conversion for digital image of the present invention.

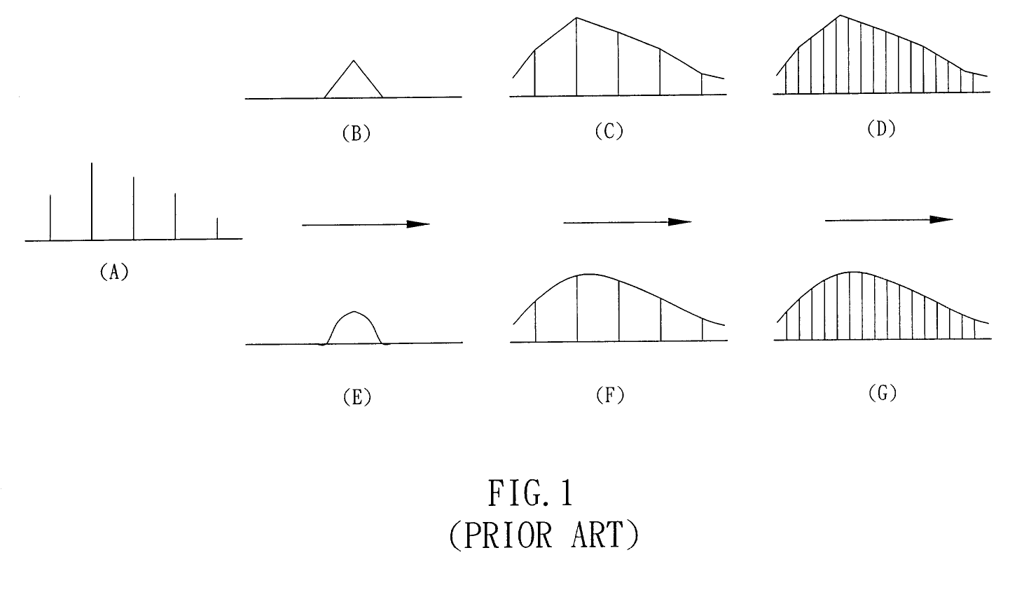

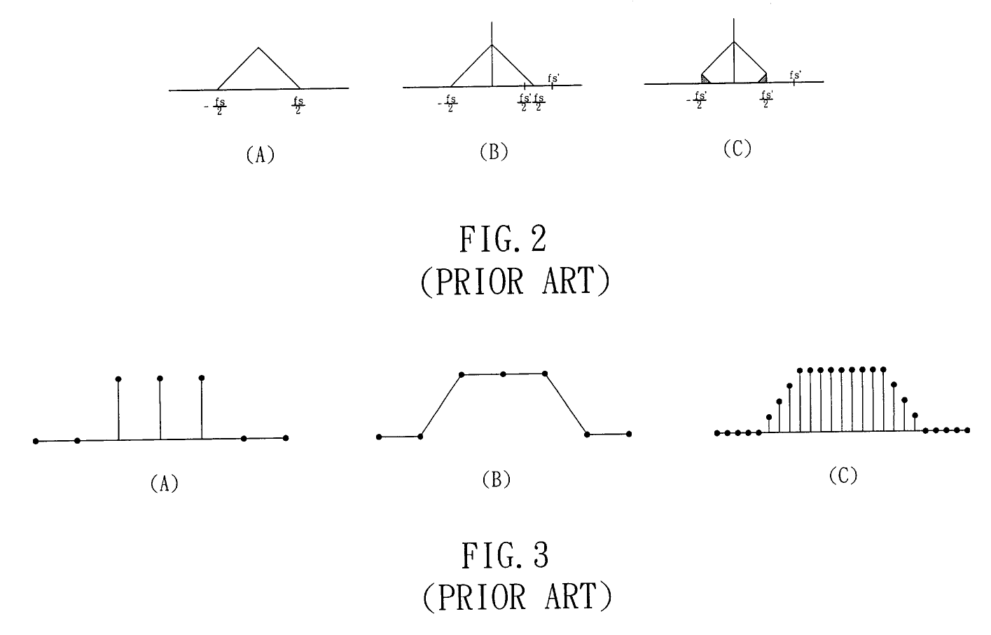

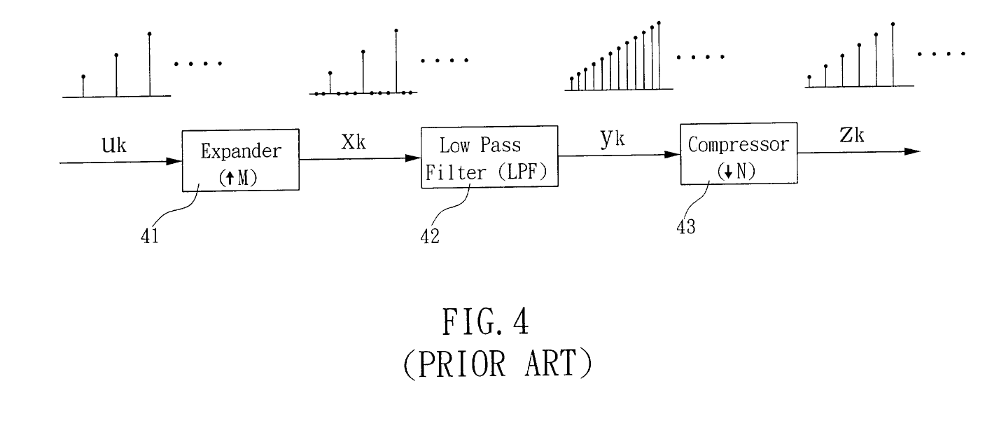

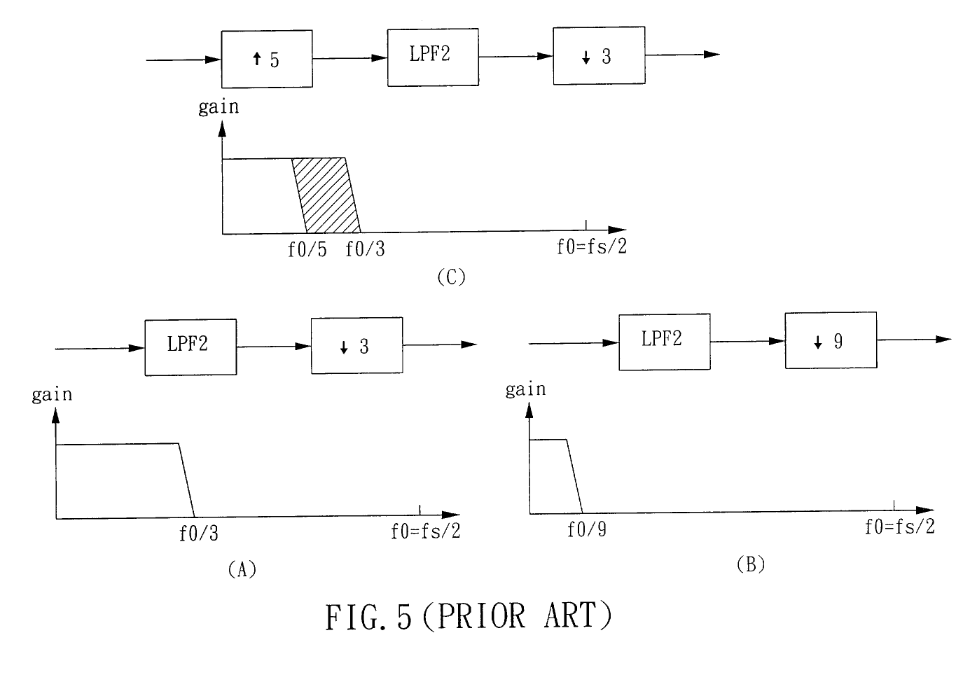

### DETAILED DESCRIPTION OF THE PRESENT INVENTION

The following embodiments will illustrate the device and the method of the sample rate conversion for digital image of the present invention in detail format.

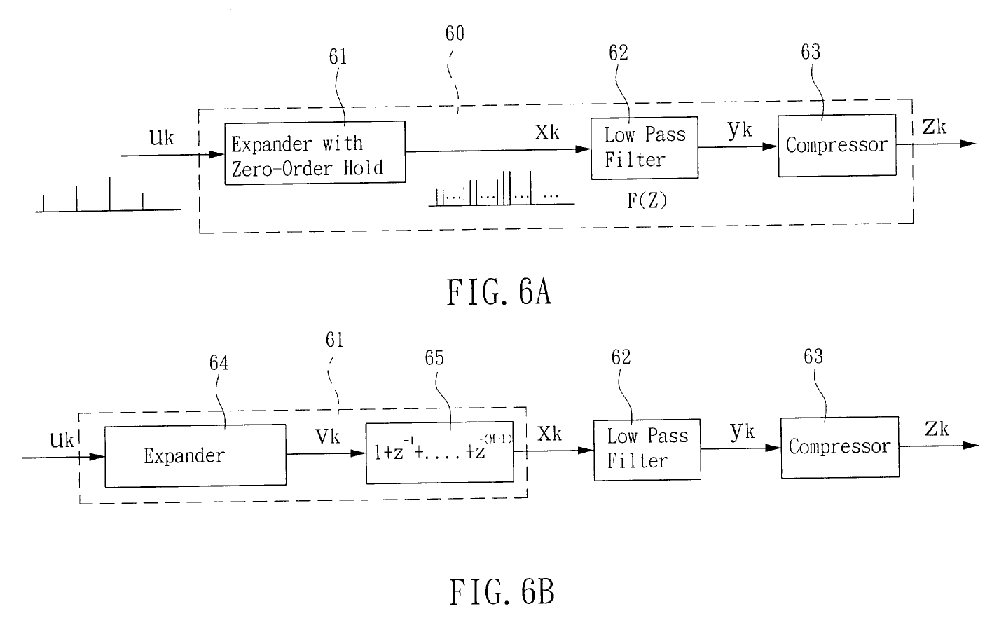

FIG. 6 shows the structure diagram of the sample rate conversion for digital image of the present invention.

As shown in FIG. 6, the device of the sample rate conversion for digital image of the present invention 60 comprises a expander 61 that is ratio-adjustable and repeated M times, a low pass filter (LPF) 62 and a fix ratio decimator 63. The sample rate conversion 60 of the present invention will adjust the ratio M of the expander 61 that repeats M times based on the adjusting ratio of the image, while the ratio N of the decimator 63 is fixed. The expander 61 that repeats M times will repeat every signal of the input signal uₖ by M times to fulfill the purpose of expanding rate. It will comply the following formula,

xₖₘ₊₁=uₖ, where 1=0 . . . M−1 (6)

Therefore, the output signal xₖ of the expander 61 that repeating M times is employing the sample-and-hold to increase the resolution of the image by M times. From the view of vision, there is no obvious difference between the xk and the original image uk. The xk is transformed to be the low pass filtered signal yk by the LPF 62, then further processed by the fix ratio decimator 63 to generate the output signal zk, which just like the xk is shrink by the fix-ratio N and transformed to be digital image zk. Since the sample rate of the output signal is lower than the one of the input signal, so, the rate that LPF needs to filter is only related to the decimating ratio N. In the present invention, the N is fixed, the parameter used for the LPF 62 is not necessary to be designed for different decimating ratio.

The structure in FIG. 6(B) provides the same function as in FIG. 6(A). Wherein, the ratio-adjustable expander 64 in FIG. 6(B) is connected with the LPF 65 and its function is as same as the expander 61 that repeating M times in FIG. 6(A). In FIG. 6(B), within the input signal uk of the expander 64, M−1 0s will be inserted between two points to fulfill the purpose of expanding the rate by M times, which means,

$${v}_{n} = \{ \begin{matrix}{u}_{k} , & when n = k \cdot M \\ 0 , & otherwise\end{matrix} \qquad ( 7 )$$

while, the impulse response of the LPF 65 is a serial of M 1s, which means its transfer function is 1+z⁻¹+ . . . +z^{-(M-1)}, its output signal is

$${x}_{kM + l} = {\sum }_{i = 0}^{M - 1} {v}_{( kM + l ) - i}^{2} = {u}_{k} , where l = 0 ⋯ M - 1 \qquad ( 8 )$$

As shown, the function in FIG. 6(A) is as same as the one in FIG. 6(B).

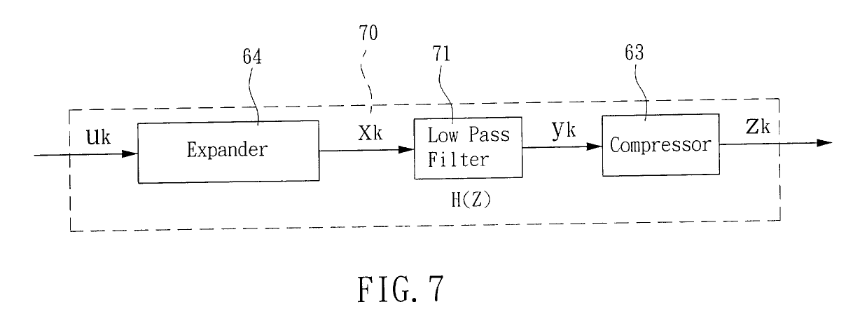

FIG. 7 is showing another structure of the present invention. As shown, the LPF 71 of the device of the sample rate conversion 70 of the present invention is equivalent to the connection of the LPF 65 and the LPF 62 in FIG. 6(A). Since the transfer function of the LPF 65 is 1+z⁻¹+. . . +z^{-(M-1)}, if the impulse response of the LPF 62 is fi, the transfer function F(z) is

$$F ( z ) = {\sum }_{i = 0}^{L - 1} {f}_{i} {z}^{- i} \qquad ( 9 )$$

so, the transfer function H(z) of the LPF 71 is

H(z)=(1+z⁻¹+ . . . +z^{-(M-1)})F(z) (10)

that is, the H(z) has certain factor 1+z⁻¹+ . . . +z^{-(M-1)}.

The structure in FIG. 7 is equivalent to the structure in FIG. 6(A) and FIG. 6(B), however, the ratio M of the expander 64 is not fixed, so the transfer function H(z) of the LPF 71 is not a fixed function, which cause some difficulty in implementation. In practice, the LPF will be a serially connected one shown in FIG. 6(A) and FIG. 6(B).

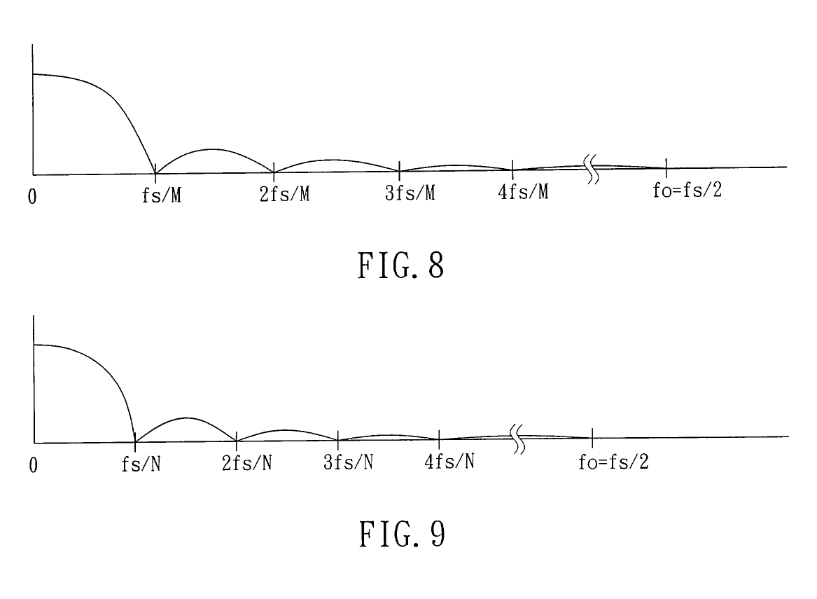

The eye of human being is vary sensitive to the tiny change of the brightness in a fix brightness portion of a image, so, how to erase the alias effect caused by the sample rate transforming is vary important. In general, the declination of the stopband of the LPF is limited, the high rate that being thru declination still wrap over back to the low rate to cause the alias effect. However, the H(z) has the factor of 1+z⁻¹+ . . . +z^{'(M-1)}, and the position of the rate response of the factor 1+z⁻¹+ . . . +z^{-(M-1)} that is zero is the entire position of the rate that DC create the image rate after expanding (as shown in FIG. 8). Therefore, even the declination of the stopband of the LPF is limited, the entire image rate generated by the DC will be filtered out completely. So, the image with fix brightness will not have any alias effect after decimating by the decimator 63.

In order to avoid the hyper low rate of the alias effect, the LPF 71 of the present invention includes some certain factor. If the fix ratio of the decimator 63 is N, the transfer function H(z) of the LPF 71 has to have some certain factor 1+z⁻¹+ . . . +z^{-(M-1)}, which means the H(z) will comply the formula (11):

H(z)=(1+z⁻¹+ . . . +z^{-(N-1)})G(z) (11)

wherein, the position of the rate zero of the rate response of (1+z⁻¹+ . . . +z^{-(N-1)}) is the position of the every rate that wrap over back to the DC after decimating (shown in FIG. 9). The G(z) is the quotient of H(z) divided by factor (1+z⁻¹+ . . . +z^{-(N-1)}) without remainder. Thus, the alias effect of hyper low rate that caused by the decimator 63 after decimating will be filtered out by the LPF 71. And, because the LPF 62 is equivalent to the combination of the LPF 65 and the LPF 62, that is, H(z)=(1+z⁻¹+ . . . +z^{-(M-1)})F(z), therefore, the F(z) should be divided by the aforesaid (1+z⁻¹+ . . . +z^{-(N-1}) without remainder, which means the (1+z⁻¹+ . . . +z^{-(N-1)}) is the factor of the F(z).

If the sample rate conversion is adapting the structure described in FIG. 6(A) and FIG. 6(B), in the input function xi of the LPF 62, the situation that only one signal not zero and all M−1 signals zeros will not exist. If the LPF 62 is based on the formula (12), the times of calculation will be increased by M times.

$${y}_{n} = {\sum }_{i = 0}^{L - 1} {f}_{i} {x}_{n - i} \qquad ( 12 )$$

To solve this problem, the present invention will accumulate the factor fi of the LPF 62 as formula (13) and (14).

$$\begin{matrix}{s}_{k} = {\sum }_{i = 0}^{k} {f}_{i} & ( 13 ) \\ {s}_{L - 1} = {\sum }_{i = 0}^{l - 1} {f}_{i} = 1 & ( 14 )\end{matrix}$$

More, when i>=L, fi will be 0, the si can be regarded to be 1. From the formula (15), if the si of the LPF 62 can be predetermined, the times of calculation of the LPF 62 will be reduced extremely.

$$\begin{matrix}{y}_{kM + l} = {\sum }_{i = 0}^{L - 1} {f}_{i} {x}_{kM + l - i} \\ = ( f0 \cdot xkM + 1 + f1 \cdot xkM - 1 + ⋯ + f1 \cdot xkM ) + \\ ( f1 + 1 \cdot x ( k - 1 ) M + ( M - 1 ) + f1 + 2 \cdot x ( k - 1 ) M + \\ ( M - 2 ) + ⋯ + f1 + M \cdot x ( k - 1 ) M ) + ( f1 + M + 1 \cdot \\ x ( k - 2 ) M + ( M - 1 ) + f1 + M + 2 \cdot x ( k - 2 ) M + \\ ( M - 2 ) + ⋯ + f1 + 2 M \cdot x ( k - 2 ) M + ⋯ \\ = ( f0 + f1 + ⋯ + f1 ) \cdot uk + ( f1 + 1 + f1 + 2 + ⋯ + \\ f1 + M ) \cdot uk - 1 + ( f1 + M + 1 + f1 + M + 2 + ⋯ + \\ f1 + 2 M ) \cdot uk - 2 \\ = s1 \cdot uk + ( s1 + M - S1 ) \cdot uk - 1 + \\ ( s1 + 2 M - S1 + M ) \cdot uk - 2 + ⋯\end{matrix} \qquad ( 15 )$$

Comparing with the times of calculation (formula (3)) of the LPF in prior art, the present invention only need to perform a (si-si-m) calculation before factor hi.

The following embodiment will illustrate a example that the ratio of the image will be changed between 25% to 200%. In the example, the M will be defined as a variable that changes between 25% to 200% depending on the ratio and the N will be set up to 100. The present invention will adapt the LPF

$$F ( z ) = {\sum }_{i = 0}^{399} {f}_{i} {z}^{- i} ,$$

wherein, F(z) has the factor (1+z⁻¹+ . . . +z⁻⁹⁹). The factor of the F(z) can be designed by any conventional technology, once the factor be found, the information of

$${s}_{k} = {\sum }_{i = 0}^{k} {f}_{i}$$

can be obtained.

If a digital image with 800*600 pixels needs to be shrunk to be 77% of the origin, the M will be set to 77. First, the one dimension sample rate conversion will be applied on the every row of the pixels u(i,j) of the input image. That means the present invention will transform the every row of the signal and then every column. If v(i,k) is representing the new image after the row transformation, the v(i,k) will comply the formula (16):

$$v ( i , k ) = s1 \cdot u ( i , t ) + ( s M + 1 - s1 ) \cdot u ( i , t - 1 ) + ( s2M + 1 - s77 + 1 ) \cdot u ( i , t - 2 ) + … \qquad ( 16 )$$

wherein, the range of i is between 0 to 799, and the range of k is between 0 to 461(600*77%−1). t is the quotient of kN divided by M ( 100 k divided by 77), 1 is the remainder. The suffix i of the si is less than 400, the surplus is si=s399=1. Thus, the every single data of the image after transformation will be calculated through formula (16). Once the transformation of the row data finished, same idea will apply to the column data. If y(k,j) is representing the new image after the column transformation, the y(k,j) will comply the formula (17):

$$v ( k , j ) = s1 \cdot u ( t , j ) + ( s M + 1 - s1 ) \cdot u ( t - 1 , j ) + ( s2M + 1 - s77 + 1 ) \cdot u ( t - 2 , j ) + … \qquad ( 17 )$$

wherein, the range of k is between 0 to 615(800*77%-1), and the range of j is between 0 to 461. t is the quotient of kN divided by M ( 100 k divided by 77), 1 is the remainder. The suffix i of the si is less than 400, the surplus is si=s399=1. y(i,j) will represent the every single pixels of the new image after shrunk 77%.

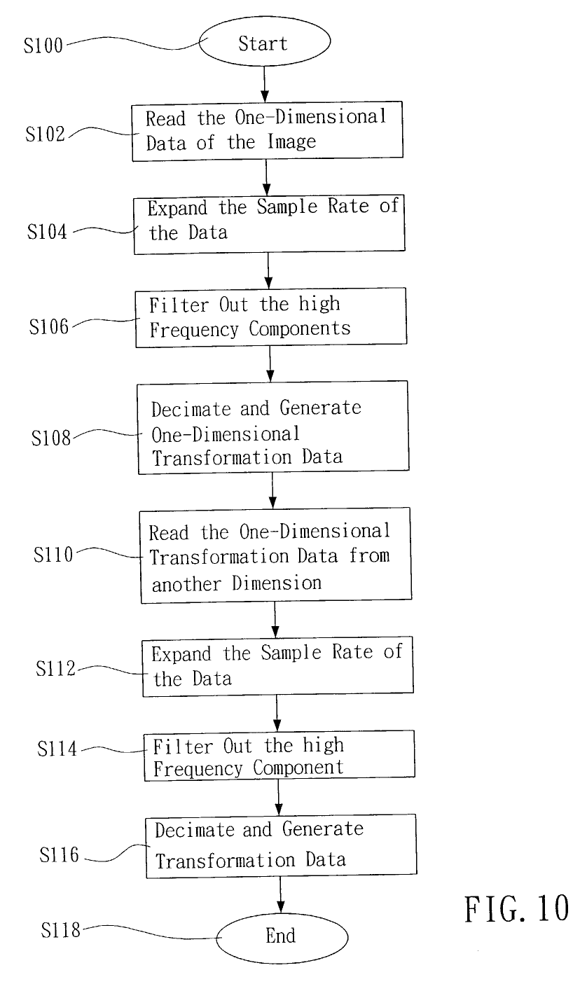

FIG. 10 shows the flow chart of the method of the sample rate conversion for digital image of the present invention. As shown, the present invention will transform every row of the image and then every column. It comprises the following steps:

Step S100: start.

Step S102: read the one dimension data of the image.

Step S104: expand the rate according to the one dimension data based on the ratio and generate the expanded signal by M times.

Step S106: filter out the high rate signal of the expanded signal and generate the filtered signal.

Step S108: decimate the rate of the filtered signal by fix ratio N and generate one dimensional transformation data.

Step S110: read and transform the one dimensional transformation data from another dimension and generate the expanded signal that being increased M times.

Step S112: filter out the high rate signal of the expanding signal and generate the filtered signal.

Step S114: decimate the rate of the filtered signal by fix ratio N and generate transformation data.

Step S116: end.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the sprit of the present invention. For example, the embodiment for transformation is illustrating the row transformation applying first, the column transformation second, however, the sequence can be reversed. Or, in FIG. 7, the expanding ratio M is adjustable and the decimating ratio N is fixed, while the scenario can be reversed.

What is claimed is:

1. A sample rate conversion device for digital image, which comprising:
a expander that is ratio-adjustable and repeating M times, which is used to receive image signal, increase the rate of the image M times by repeating every pixels M times based on the adjusting ratio for the image to generate a expanding signal;
a low pass filter (LPF), which is used to receive the expanding signal of the expander, filter out the high rate and output the filtered signal; and
a fix ratio decimator, which is used to receive the filtered signal, low down the sample rate by N times and generate the output signal.

2. A sample rate conversion device for digital image of claim 1, wherein, the transfer function of the LPF includes factor 1+z−1+ . . . +z−(N−1).

3. A sample rate conversion device for digital image, which comprising:
a ratio-adjustable expander, which is used to receive image signal, increase the sample rate of the image M times based on the adjusting ratio for the image to generate a expanding signal;
a low pass filter (LPF), which is used to receive the expanding signal of the expander, filter out the high rate and output the filtered signal; and
a fix ratio decimator, which is used to receive the filtered signal, low down the sample rate by N times and generate the output signal;
the transfer function of the LPF includes factor 1+z−1+ . . . +z−(M−1), which the M is adjustable and the N is fix.

4. A sample rate conversion device for digital image of claim 3, wherein, the transfer function of the LPF includes factor 1+z−1+ . . . +z−(N−1).

5. A sample rate conversion device for digital image, which comprising:
a fix ratio expander, which is used to receive image signal, increase the sample rate of the image signal M times to generate a expanding signal;
a low pass filter (LPF), which is used to receive the expanding signal of the expander, filter out the high rate and output the filtered signal; and
a ratio adjustable decimator, which is used to receive the filtered signal of the LPF, low down the sample rate by N times based on the adjusting ratio for the image and generate the output signal;
wherein, the transfer function of the LPF includes factor 1+z−1+ . . . +z−(M−1), in which the M is fix and the N is adjustable.

6. A sample rate conversion device for digital image of claim 5, wherein, the transfer function of the LPF includes factor 1+z−1+ . . . +z−(N−1).

7. A sample rate conversion method for digital image, which applies the sample rate conversion on the column and the row of the image, and every sample rate conversion including the following step:
step of expanding, which increasing the sample rate of one dimension data by M times based on the adjusting ratio for the image and generating expanding signal;
step of filtering signal, with the transfer function that including the factor 1+z−1+ . . . +z−(N−1), the LPF filters out the high rate of the expanding signal and output the filtered signal; and
step of decimating, which receiving the filtered signal, lowing down the sample rate by N times and generating output signal;
wherein, the value of the M will be changed according to the adjusting ratio fro the image and the value of the N is fix.
